(19) United States
(12) Patent Application Publication
(10) Pub. No.: US 2025/0058434 A1
(43) Pub. Date: Feb. 20, 2025

(54) DRIVE ASSEMBLY FOR A TORQUE WRENCH

(71) Applicant: ATLAS COPCO INDUSTRIAL TECHNIQUE AB, Stockholm (SE)

(72) Inventors: Ian O'BRIEN, Cramlington Northumberland (GB); Joseph GILL, Cramlington Northumberland (GB); Tony DODDS, Cramlington Northumberland (GB); Teresa O'BRIEN, Cramlington Northumberland (GB)

(21) Appl. No.: 18/720,186

(22) PCT Filed: Dec. 14, 2022
(86) PCT No.: PCT/IB2022/062231

§ 371 Date: Jun. 14, 2024

(30) Foreign Application Priority Data
Dec. 15, 2021 (GB) 2118151.6

(51) Int. Cl. B25B 21/00

(52) U.S. Cl. CPC B25B 21/005

(57) ABSTRACT

A drive (11) assembly (10) of a torque wrench (1), the drive (11) assembly (10) comprising: a ratchet (14), having internal splines (13a; 14a); a drive (11), comprising a shaft (11b) arranged to be removably received within the ratchet (14), the shaft (11b) passing through the ratchet (14) and having external splines (11a) arranged to mesh with the splines of the ratchet (14) such that rotation of the ratchet (14) rotates the shaft (11b); and a drive sleeve (13), arranged to be seated on the ratchet (14) and having internal splines (13a; 14a) matching the internal splines (13a; 14a) of the ratchet (14). The drive sleeve (13) and ratchet (14) comprise cooperating features arranged to prevent relative rotation of the drive sleeve (13) and ratchet (14) when the drive sleeve (13) is seated on the ratchet (14). Improvement of the case of use of the tool is enabled.

This invention relates to tools, and particularly to drive assemblies of tools such as, non-exclusively, hydraulic wrenches.

Torque wrenches, such as hydraulic torque wrenches, are well known in the prior art and widely used where a torque is to be applied, e.g. to a nut, bolt, or other fastener. Atlas Copco provides a hydraulic torque wrench, as do other suppliers, which comprise a releasable drive (typically a square drive, although a differently-shaped drive, e.g. a hexagon drive or a socket drive, may be used). One or more drive sleeves may be used to assist with insertion and/or positioning of the drive. One or more releasable retainers may be used to retain the drive and drive sleeves in place.

In order to reverse the direction of rotation, it is necessary to remove the square drive component and position it on the opposite side of the tool. When changing the drive direction, the operator must handle multiple components simultaneously, in particular the wrench, square drive (and socket), and one or more retainers. A retainer can easily be dropped and lost, potentially rendering the tool dangerous or unusable, and other components may end up misaligned. In particular, drive sleeves may rotate freely once the square drive is removed. Generally, an operator is required to manually realign the drive sleeves in order to reinsert the drive from the opposite side of the tool. The same considerations apply when replacing the drive (e.g. for a different shape or size, or in case of excessive wear).

It is desired to improve the ease of use of the tool.

According to a first aspect of the invention, there is provided a drive assembly of a torque wrench, the drive assembly comprising:
a ratchet having internal splines;
a drive comprising a shaft arranged to be removably received within the ratchet, the shaft passing through the ratchet and having external splines arranged to mesh with the splines of the ratchet such that rotation of the ratchet rotates the shaft; and
a drive sleeve arranged to be seated on the ratchet and having internal splines matching the internal splines of the ratchet.

The drive sleeve and ratchet comprise cooperating features arranged to prevent relative rotation of the drive sleeve and ratchet when the drive sleeve is seated on the ratchet.

As a result, the drive sleeve cannot rotate independently from the ratchet when the drive is removed, so enhancing the user experience and speeding up the drive change process (e.g. when changing direction or drive type).

As compared to prior art drive assemblies, alignment of the drive sleeve and ratchet may therefore be facilitated, for example when removing and reinserting a drive.

The drive sleeve and ratchet may comprise multiple pairs of cooperating features arranged to prevent relative rotation of the drive sleeve and ratchet when the drive sleeve is seated on the ratchet.

The cooperating features of the drive sleeve and ratchet may comprise a keyway on the ratchet, and a key on the drive sleeve, the key being arranged to fit within the keyway.

The ratchet and drive sleeve may each have a lip extending parallel to the length of the shaft in use, the lip of the drive sleeve being arranged to be slidingly received within the lip of the ratchet. The cooperating features may be provided on the lips.

The cooperating features are oriented with respect to the internal splines so as to align the internal splines of the ratchet with those of the drive sleeve when engaged.

The drive assembly may further comprise a retainer (or multiple retainers) arranged to hold the drive sleeve in place within the housing.

The drive assembly may further comprise a second drive sleeve, the second drive sleeve being arranged to be seated on the far side of the ratchet from the first drive sleeve. The second drive sleeve may also have internal splines matching the internal splines of the ratchet. The ratchet may comprise a second lip extending parallel to the length of the shaft in use, on the far side of the ratchet from the first lip, the lip of the second drive sleeve being arranged to be slidingly received within the second lip of the ratchet. The cooperating features may be provided on the lips.

The first and second drive sleeves may be identical.

In embodiments with multiple drive sleeves, the drive assembly may comprise one or more retainers arranged to hold each drive sleeve in place within the housing.

The drive may be a square drive.

According to a second aspect of the invention, there is provided a torque wrench comprising a drive assembly in accordance with the first aspect.

The torque wrench may be a hydraulic drive torque wrench.

According to a third aspect of the invention, there is provided a kit of components for forming into a torque wrench, the kit comprising:
a housing;
a ratchet arranged to be mounted on the housing and having internal splines;
a drive comprising a shaft arranged to be removably received within the housing, the shaft passing through the ratchet and having external splines arranged to mesh with the splines of the ratchet such that rotation of the ratchet rotates the shaft; and
a drive sleeve arranged to be seated on the ratchet within the housing and having internal splines matching the internal splines of the ratchet.

The drive sleeve and ratchet comprise cooperating features arranged to prevent relative rotation of the drive sleeve and ratchet when the drive sleeve is seated on the ratchet.

The kit may comprise a plurality of interchangeable drives.

The kit may comprise a plurality of drive sleeves. In embodiments with two drive sleeves, one may be seated on each side of the ratchet, and each may have internal splines matching the internal splines of the ratchet.

The ratchet, drive, and drive sleeve of the kit of components, taken together, may form a drive assembly as described with respect to the first aspect.

There now follows, by way of example only, description of an embodiment of the invention, described with reference to the accompanying drawings, in which:

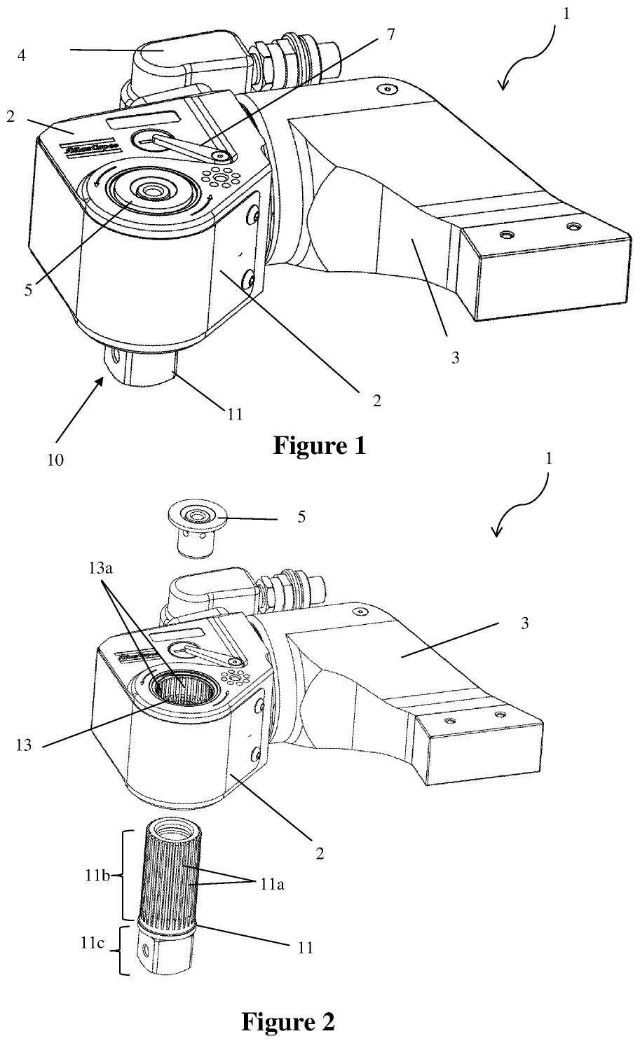

FIG. 1 shows a perspective view of a square drive hydraulic wrench, showing the square drive in the context of the tool, with the drive installed;

FIG. 2 shows a perspective the square drive hydraulic wrench shown in FIG. 1, with the drive removed;

FIG. 3 shows a sectional perspective view of a portion of the square drive hydraulic wrench shown in FIGS. 1 and 2, focusing on the drive assembly; and

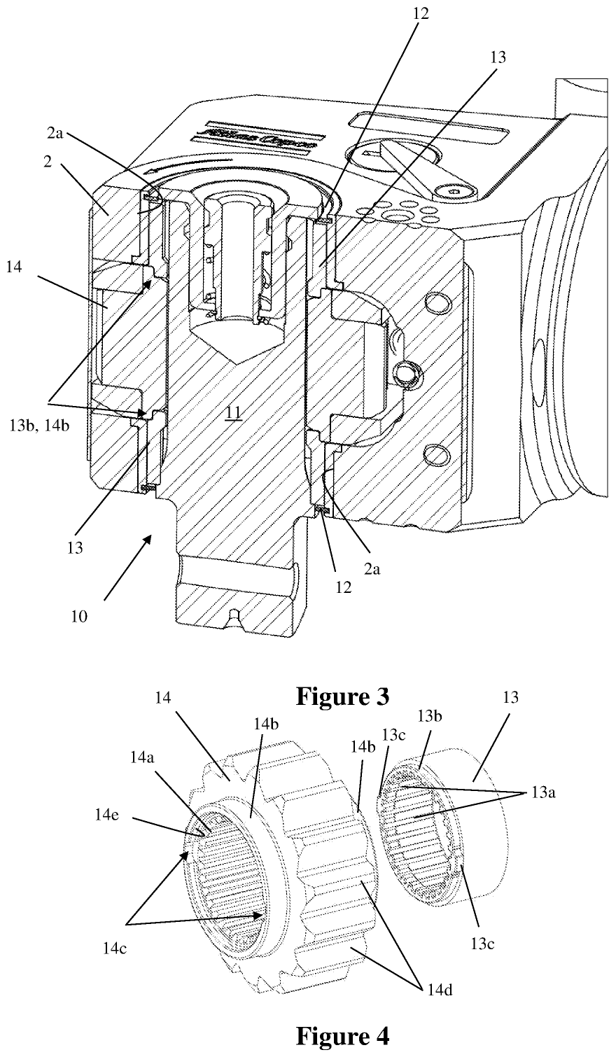

FIG. 4 shows a perspective view of a drive sleeve and ratchet of the hydraulic wrench shown in the earlier figures.

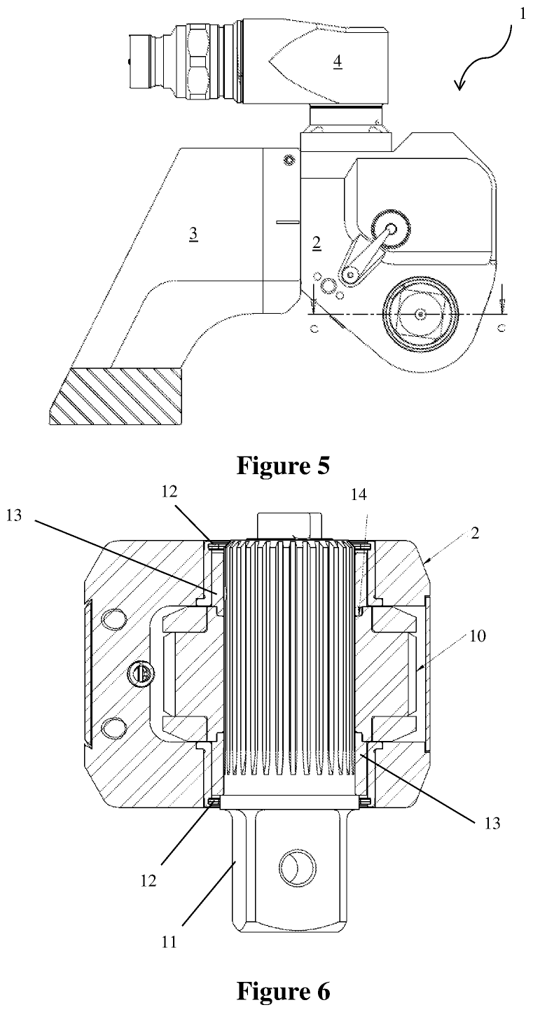

FIG. 5 shows a plan view of a square drive hydraulic wrench similar to that shown in FIG. 1, with the drive installed, marking a line C;

FIG. 6 shows a sectional view of the square drive hydraulic wrench of FIG. 5, cut along line C;

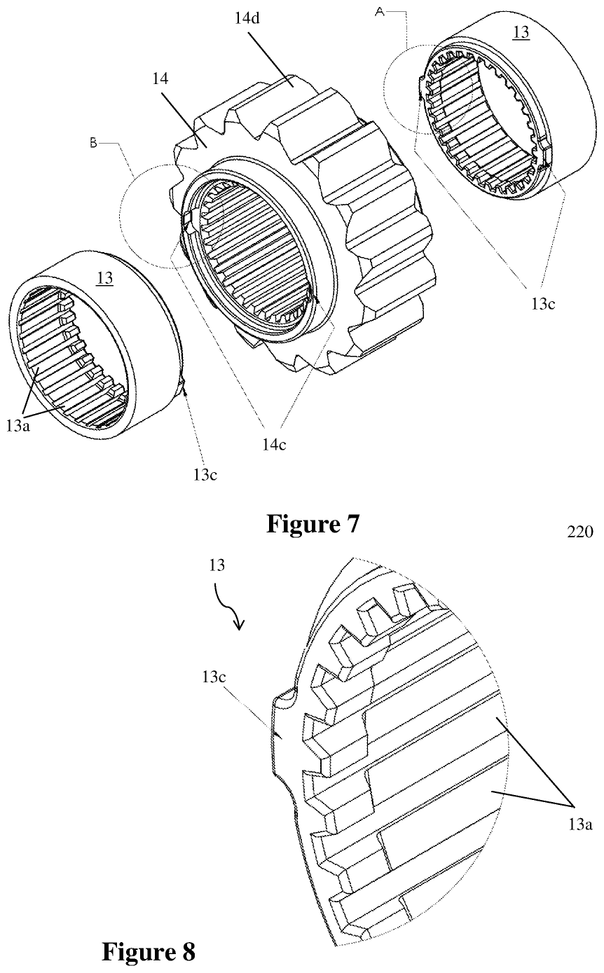

FIG. 7 shows a perspective view of the ratchet and drive sleeves of the hydraulic wrench of FIG. 5, highlighting features A and B of the drive sleeves and ratchet, respectively;

FIG. 8 shows a close-up perspective view of feature A of the drive sleeve shown in FIG. 7; and

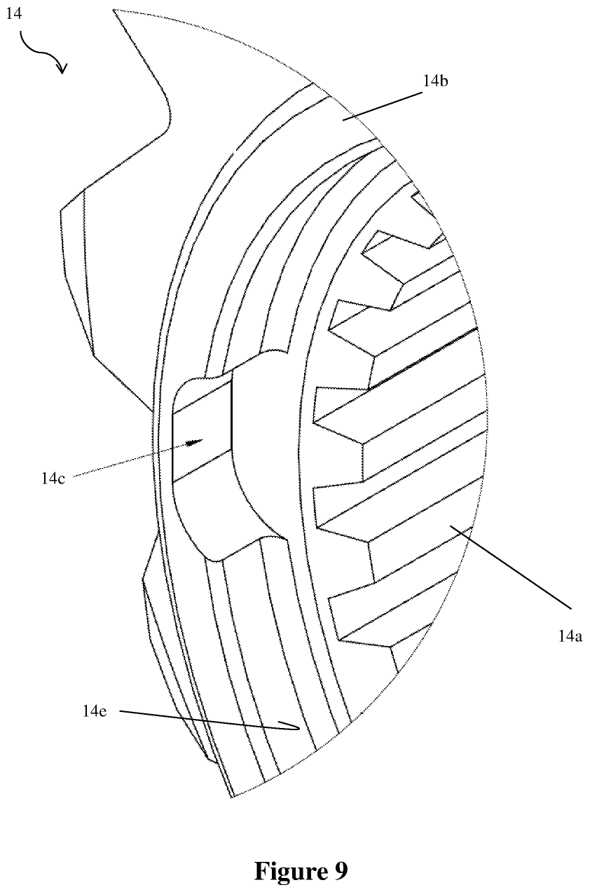

FIG. 9 shows a close-up perspective view of feature B of the ratchet shown in FIG. 7.

It will be appreciated that whilst embodiments of the invention are primarily depicted and described with respect to a square drive, different drives may be used in other embodiments. The term “square drive” is therefore used by way of illustrative example only, and is not intended to be limiting.

FIG. 1 shows a tool 1, and more specifically a square drive hydraulic wrench 1, of an embodiment of the invention.

The tool 1 comprises a housing 2 on which is mounted a drive assembly 10. The tool further comprises a reaction arm 3 and a swivel assembly 4. The reaction arm 3 and swivel assembly 4 may be of any type known to the skilled person, and/or one or both may not be present in other embodiments. For example, the swivel assembly 4 may be replaced by a different form of hose connector to allow a hydraulic tool 1 to be connected to a pump (not shown), or a completely different power source may be connected for a non-hydraulic tool (e.g. for an electrically-powered tool).

The drive assembly 10 comprises a drive 11, which is more specifically a square drive 11 in the embodiment shown. Different drives 11 may be used in other embodiments.

The drive assembly 10 also comprises a ratchet 14. The ratchet 14 has external teeth, or splines, 14d arranged to interlock with a mechanism (not shown) within the housing 2 of the tool 1, so as to cause the ratchet 14 to rotate when the tool I is powered. Any suitable mechanism known in the art may be used to cause the ratchet to rotate.

In the embodiment being described, the drive assembly 10 is received within a bore or passageway 2a which passes through the housing 2. The passageway 2a is at least substantially cylindrical near the entrance and exit in the embodiment shown, and widens in a middle portion so as to accommodate the ratchet 14.

The drive assembly 10 further comprises a pair of drive sleeves 13; the drive sleeves are arranged to be inserted one into each end of the passageway 2a so as to support and locate the drive 11. The drive sleeves 13 may be described as bushings, as they provide a generally cylindrical lining for an opening and serve as a guide.

Each drive sleeves 13 serve to align the ratchet 14, and more specifically a spline axis of the ratchet, with the bore 2a of the housing 2. The drive sleeves 13 also provide bearing surfaces to keep the housing 2 and the drive 11 in alignment. In the embodiment pictured, each drive sleeve 13 is held into the housing 2 by a retaining clip 12.

One or more retainers 12, e.g. retaining clips, are used to retain the drive sleeves 13 within the housing 2 in use. In the embodiment shown, the retaining clips 12 are arranged to be retained in the housing 2 even when the drive 11 is removed from the housing. In FIG. 1, the retaining clips 12 are occluded, but these are visible in FIGS. 3 and 6. In particular, the upper retaining clip 12 is hidden by a square drive retainer 5 in the orientation shown in FIG. 1. The drive retainer 5 prevents the square drive 11 from sliding out of the tool 1. The design of drive retainer 5 shown is provided by way of example only and is not intended to be limiting—an alternative component or feature may take its place in other implementations.

In other embodiments, only a single drive sleeve 13 may be used, or more than two drive sleeves 13 may be used. The drive sleeves 13 are substantially ring-shaped or cylindrical in shape. The external surface of each drive sleeve 13 is arranged to be a sliding fit with the passageway 2a, and is smooth in the embodiment shown. The drive sleeves 13 are arranged to be able to rotate within the passageway with little or no resistance, and to slide into and out of the passageway.

In the embodiment shown, the ratchet 14 and drive sleeves 13 each have an at least substantially circular aperture therethrough; the apertures are arranged to be aligned and the drive 11 received therein. The ratchet 14 and drive sleeves 13 each have internal splines. In the embodiment shown, these internal splines 13a, 14a are oriented parallel to the length of the passageway and perpendicular to the cross-section of the circular aperture therethrough. In the embodiment shown, the internal splines 13a of the drive sleeves 13 match those of the ratchet 14a in both width and spacing. In alternative embodiments, the drive sleeves 13 may have fewer internal splines 13a than the ratchet 14, however these splines 13a are still located so as to align with splines 14a of the ratchet 14 (some ratchet splines 14a may not have a paired drive sleeve spline 13a).

The drive 11 has an at least substantially cylindrical shaft 11b and a head 11c. The head 11c has an at least substantially square cross-section in the embodiment shown, as the drive 11 is a square drive. Differently shaped and/or sized heads may be provided in other embodiments.

The shaft 11b is arranged to pass through the housing 2, and more specifically through the drive sleeve 13—ratchet 14—drive sleeve 13 sequence within the passageway 2a. The drive 11 has external splines 11a on the shaft 11b which are aligned with, and arranged to mesh with, the internal splines 13a, 14a of the drive sleeves 13 and ratchet 14 in use.

Rotation of the ratchet 14 when the tool 1 is powered therefore causes the drive 11 to rotate, due to the interaction of the splines 11a, 14a. The drive sleeves 13 are arranged to rotate with the ratchet 14 and drive 11.

The drive sleeves 13 assist in forming a connection between the housing 2 and the rest of the drive assembly 10.

In the embodiment shown, each drive sleeve 13 has a small spigot 13b—i.e. the edge of the drive sleeve 13 arranged to be adjacent to the ratchet 14 is shaped to enter into an enlarged edge of the ratchet 14 to form a joint, as is known for pipes. (The term “spigot” is used herein for brevity in the British English sense of the end of a pipe that enters the enlarged end of another pipe to form a joint, not in the American English sense of a faucet.) The ratchet 14 correspondingly has a stepped opening, or counterbore 14e, on either side of the ratchet 14. For each drive sleeve 13, the spigot 13b is arranged to be located within the counterbore 14e on the corresponding side of the ratchet 14 in use, when the drive sleeves 13 are inserted into the passageway 2a. This formation is described above as a counterbore 14e due to the shape, but it will be appreciated that this term is not intended to limit the formation to being made by drilling—the ratchet 14 may be manufactured in any suitable way.

In particular, in the embodiment shown the ratchet 14 comprises a central egg-like portion, with external teeth and internal splines 14a, and a circular rim 14b extending outwardly on each side of the cog-like portion. The rim 14b may also be referred to as a lip 14b, and, in the embodiment shown, an inner surface of the lip 14b provides the counterbore 14e. The internal splines 14a stop before the circular rim 14b. At least due to the lack of internal splines 14a, the rim 14b therefore provides a wider opening than the cog-like portion of the ratchet 14. Correspondingly, one side of each drive sleeve 13 is stepped inwards, forming a narrower rim, or neck, which functions as a spigot 13b. The neck 13b is sized and shaped to fit within the rim 14b of the ratchet 14.

The spigot and counterbore arrangement 13b, 14e may alternatively be described as the ratchet 14 and drive sleeve 13 each having a lip 13b, 14b extending parallel to the passageway 2a/to the internal splines 13a, 14a, with the lips 13b, 14b being sized and shaped such that the lip 13b of the drive sleeve 13 can be slidingly received within the lip 14b of the ratchet 14. In the embodiment being described, the cooperating features are provided on the lips 13b, 14b.

The lips 13b, 14b comprise cooperating features 13c, 14c arranged to prevent relative rotation of the drive sleeve 13 and ratchet 14 when the drive sleeve 13 is seated on the ratchet 14. The cooperating features interlock, so connecting the drive sleeves 13 to the ratchet 14 such that they rotate with the ratchet 14. In alternative embodiments, the drive sleeves 13 and ratchet 14 may have a different design, optionally without a spigot or counterbore, or with a rim of the ratchet 14 fitting within the drive sleeve 13 rather than vice versa, and/or the cooperating features 13c, 14c may be provided on a different part of each.

In the embodiment being described, the cooperating features of the ratchet 14 comprise two keyways, or channels 14c. The channels 14c are arranged parallel to the internal splines 14a, and therefore to the length of the passageway 2a, and extend the height of the rim 14b. The channels 14c are located opposite each other in the embodiment shown, and are symmetrical such that the drive sleeve 13 can fit onto the ratchet 14 in two different orientations. The cooperating features of the drive sleeve 13 comprise two keys, or protrusions 13c. The protrusions 13c are located, sized, and shaped to be a sliding fit with the channels 14c. The protrusions 13c take the form of blocks extending outwardly from the narrower rim 13b of the drive sleeve 13, along the height of the rim 13b. The lip/spigot 13b of the drive sleeve 13 can therefore be slid into the counterbore 14e provided by the rim 14b of the ratchet 14 in only two positions, with the cooperating features 13c, 14c aligned and fitting together.

The cooperating features 13c, 14c are positioned such that the internal splines 13a of the drive sleeve 13 necessarily align with the internal splines 14a of the ratchet 14 when the rim 13b of the drive sleeve 13 is inserted into the ratchet 14.

In alternative or additional embodiments, only a single key 13c and keyway 14c may be provided, or more than two pairs of keys and keyways may be provided. In some embodiments, more keyways 14c may be provided than keys 13c, such that one or more keyways 14c remain empty in use. In some embodiments, one or more of the keys may be located on the ratchet 14 and the keyways on the drive sleeve 13.

In the embodiment pictured, the key 13c and keyway 14c have constant widths. In alternative or additional embodiments, the keyway 14c may be wider and/or the key 13c may be narrower towards the edge designed to approach and mesh with the other cooperating feature (i.e. the edge of the rim 14b further from the internal splines 14a for the ratchet 14, and the edge of the drive sleeve 13 closest to the ratchet 14). This shaping may facilitate initial engagement of the cooperating features 13c, 14c, guiding the parts together and into place. The shapes of the cooperating features 13c, 14c may then guide the drive sleeve 13 into the correct alignment with the ratchet 14 as it is pushed further into the passageway 2a. Similarly, as shown most clearly in FIGS. 7 and 8, the internal splines 13a of each drive sleeve 13 are relatively shallow over most of the length of the drive sleeve 13 in the embodiment shown, with their radial extent increasing in the vicinity of the spigot 13b only, so as to match the ratchet splines 14 where they meet. The shaped internal splines 13a of the drive sleeve 13 may help to guide the drive 11 into the correct orientation as it is inserted into the drive sleeve 13. In alternative embodiments, the shape of the splines 13a may not vary along the length of the drive sleeve 13. Alternative embodiments may have splines with a shorter extent in the axial direction, being located in the region of the spigot 13b and not extending further (at any radial extent).

In still further alternative or additional embodiments, different cooperating features 13c, 14c may be provided, instead of, or as well as, the keys and keyways described. For example, the ratchet 14 may comprise one or more pins or other protrusions extending in a direction parallel to its internal splines 14a and the drive sleeve 13 may comprise one or more apertures or opening extending in a direction parallel to its internal splines 13a and arranged to receive the pins or other protrusions of the ratchet 14, or vice versa. In such embodiments, no spigot and counterbore may be provided, and the cooperating features may extend from facing surfaces of the drive sleeve 13 and ratchet 14 arranged to abut each other in use.

In the embodiments being described, the cooperating features 13c, 14c are oriented parallel to the passageway 2a/parallel to the internal splines 13a, 14a, such that the drive sleeves 13 can be inserted by simply sliding them into the passageway 2a and onto the ratchet 14. In alternative embodiments, the cooperating features 13c, 14c may be differently oriented, for example forming a screw-thread or bayonet-type arrangement, such that relative rotation of the drive sleeves 13 and ratchet 14 is needed to fully engage the cooperating features 13c, 14c.

In use, the drive 11 is inserted into the housing 2 through a first drive sleeve 13, then through the ratchet 14, then through the second drive sleeve 13. The drive 11 is then removed and reinserted from the other side of the tool 1 if or when a change in drive direction is required, or may be removed and replaced with a different drive 11. Without the cooperating features 13c, 14c, the drive sleeves 13 would be free to rotate within the passageway 2a when the drive 11 was removed, resulting in misalignment between the one or more drive sleeves 13 and the ratchet 14. The use of cooperating features 13c, 14c therefore avoids a need for a user to manually realign the internal splines 13a, 14a in order to reinsert the/a drive 11.

The cooperating features 13c, 14c are arranged such that, for the drive sleeve 13 to be fully inserted into the housing 2, the cooperating features 13c, 14c must be correctly aligned. The cooperating features 13c, 14c are oriented relative to the internal splines 13c, 14c so as to ensure correct alignment between the drive sleeves 13 and ratchet 14 when the drive sleeves 13 are fully inserted, such that the drive sleeves 13 are seated on the ratchet 14 (i.e. contact is made between facing surfaces thereof). The cooperating features 13c, 14c also ensure that the drive sleeve(s) 13 cannot rotate independently from the ratchet when the drive 11 is removed.

In the embodiment shown, the lips 14b of the ratchet 14 and the drive sleeves 13 are symmetrical and have the same cooperating features, such that the two drive sleeves 13 are interchangeable. In other embodiments, the cooperating features on each side of the ratchet 14 may differ, for example such that each drive sleeve 13 can only fit on one side of the ratchet 14. In embodiments with more than two drive sleeves 13, an additional drive sleeve 13 may be inserted into the passageway 2a to mesh with the outer edge of a first drive sleeve 13; for example, for wider tools 1 with a longer passageway 2a. Additional cooperating features may be provided to allow the drive sleeves 13 on the same side of the ratchet 14 to mesh with each other.

Once fully inserted, the drive sleeves 13 can be secured in place using one or more retaining clips 12, and/or other retainers as known in the art.

The tool 1 shown in FIGS. 1 and 2 may also include various other features standard in the art, such as a reaction pawl within the tool 1 to provide an anti-backlash mechanism, and optionally also a reaction pawl lever 7 as shown in FIG. 1 that may be used to disengage the reaction pawl from the ratchet 14 if the tool 1 becomes locked onto the object(s) to which it was being used to apply a torque. It will be appreciated that features common in the art and well known by the skilled person are not described in detail herein but may be present, as appropriate.

1. A drive assembly of a torque wrench, the drive assembly comprising:
a ratchet having internal splines;
a drive comprising a shaft arranged to be removably received within the ratchet, the shaft passing through the ratchet and having external splines arranged to mesh with the splines of the ratchet such that rotation of the ratchet rotates the shaft; and
a drive sleeve arranged to be seated on the ratchet and having internal splines matching the internal splines of the ratchet,
and wherein the drive sleeve and ratchet comprise cooperating features arranged to prevent relative rotation of the drive sleeve and ratchet when the drive sleeve is seated on the ratchet.

2. The drive assembly of claim 1, wherein the drive sleeve and ratchet comprise multiple pairs of cooperating features arranged to prevent relative rotation of the drive sleeve and ratchet when the drive sleeve is seated on the ratchet.

3. The drive assembly of claim 1, wherein the cooperating features of the drive sleeve and ratchet comprise a keyway on the ratchet, and a key on the drive sleeve, the key being arranged to fit within the keyway.

4. The drive assembly of claim 1, wherein the ratchet and drive sleeve each have a lip extending parallel to the length of the shaft in use, the lip of the drive sleeve being arranged to be slidingly received within the lip of the ratchet, and wherein the cooperating features are provided on the lips.

5. The drive assembly of claim 1, wherein the cooperating features are oriented with respect to the internal splines so as to align the internal splines of the ratchet with those of the drive sleeve when engaged.

6. The drive assembly of claim 1, further comprising a second drive sleeve, the second drive sleeve being arranged to be seated on the far side of the ratchet from the first drive sleeve.

7. The drive assembly of claim 1, further comprising one or more retainers arranged to hold the or each drive sleeve in place within the housing.

8. The drive assembly of claim 1, wherein the drive is a square drive.

9. A torque wrench comprising a drive assembly in accordance with claim 1.

10. The torque wrench of claim 9, wherein the torque wrench is a hydraulic torque wrench.

11. A kit of components for forming into a torque wrench, the kit comprising:
a housing;
a ratchet arranged to be mounted on the housing and having internal splines;
a drive comprising a shaft arranged to be removably received within the housing, the shaft passing through the ratchet and having external splines arranged to mesh with the splines of the ratchet such that rotation of the ratchet rotates the shaft; and
a drive sleeve arranged to be seated on the ratchet within the housing and having internal splines matching the internal splines of the ratchet,
and wherein the drive sleeve and ratchet comprise cooperating features arranged to prevent relative rotation of the drive sleeve and ratchet when the drive sleeve is seated on the ratchet.

12. The kit of components of claim 11, wherein the kit comprises a plurality of interchangeable drives.

13. The kit of components of claim 11, wherein the kit comprises a plurality of drive sleeves.

14. (canceled)
